(19) United States
(12) Patent Application Publication
(10) Pub. No.: US 2005/0056814 A1
(43) Pub. Date: Mar. 17, 2005

(54) Electroactive probe comprising a chelating agent and a metal ion

(75) Inventor: Francis Garnier, Champigny Sur Marne (FR)

Correspondence Address: OLIFF & BERRIDGE, PLC, P.O. BOX 19928, ALEXANDRIA, VA, 22320, US

(73) Assignee: BIO MERIEUX

(21) Appl. No.: 10/496,655

(22) PCT Filed: Dec. 2, 2002
(86) PCT No.: PCT/FR02/04137

(30) Foreign Application Priority Data
Nov. 30, 2001 (FR) 01 15668

(51) Int. Cl. H01B 1/00

(52) U.S. Cl. 252/500

(57) ABSTRACT

The invention concerns an electroactive probe, formed with an electroactive homopolymer or copolymer polymer of at least two monomers, functionalized by chelating agent complexed with a metal ion, and anti-ligand capable of reacting specifically with a ligand, a method for preparing such a probe and a method of detecting a ligand in a biological sample using same.

The invention relates to organic electrodes prepared from electroactive polymers to which are bonded antiligands intended to interact specifically with ligands.

In the electrodes described in the prior art, the specific interaction of the antiligand with the ligand results in a perceptible and selective variation in the electrochemical properties of the electroactive polymer, such as a decrease in the electroactivity of said polymer. This variation, which depends on the concentration of grafted ligand, is observed, optionally measured and directly correlated with the amount of grafted ligand. One of the essential applications of this technique is thus the detection, identification and optionally assay of a ligand present in a biological sample.

The abovementioned variation is of potentiometric type, such as a variation in the oxidation potential of the electroactive polymer before and after interaction, or of amperometric type, such as a variation in the current for oxidation or reduction of the polymer before and after hybridization, determined at a predetermined potential.

The document WO-A-95/29199 discloses a polypyrrole composed of monomers each consisting of a pyrrole ring covalently substituted on the carbon in the 3-position of the pyrrole ring by a polynucleotide probe.

The polypyrrole thus obtained is applied to the detection, and optionally assay, of ligands, in vitro or in vivo.

In order to precisely characterize the electrochemical response of the polymer, the latter must exhibit a high electroactivity.

The ability of chelating agents, such as NTA (nitrilotriacetate) or IDA (iminodiacetate), to bind metals has already been studied with di- or trivalent metals. For example, immobilized metal affinity chromatography (IMAC) has been used to purify proteins (Porath et al., Nature, 258, 598-599 (1975)) using IDA as chelating agent. The IDA was charged with metal ions, such as Zn²⁺, Cu²⁺ or Ni²⁺, and was used to purify proteins or peptides.

Metals have specific oxidation potentials which are characteristic and which make possible their detection and their assay by electrochemistry.

However, conventional analysis by solution electrochemistry of a medium comprising metal ions makes it possible to detect amounts of ions of the order of 10⁻⁵ mol per liter. Furthermore, the detection limit of a complexing device is dependent on the amount of complexing agent used. One of the possible solutions for lowering the detection limit consists of the confinement of ionic entities on the measuring electrode through the agency of the attachment of chelating agents to the electrode.

However, it is not easy to attach a large number of chelating agents to an electrode because conventional chelating agents, such as EDTA, cannot be deposited on electrodes in layers of greater than monomolecular layers for fear of preventing the conduction of the current and of harming the sensitivity and the reliability of the detection, as only deposits of a few angstroms are conducting, and they thus do not make possible the desired confinement.

The Applicant Company has found, surprisingly, that the use of a conducting polymer as support for these chelating agents makes it possible to retain, even for relatively thick deposits of the order of approximately one hundred micrometers, the continuity of the conduction and thus to lower the detection limit to thresholds of the order of 10⁻⁹ to 10⁻¹⁰ molecules per cm².

This continuity in detection is obtained by virtue of the three-dimensional structure of the conducting polymers to which the chelating agents are attached.

These conducting polymers to which chelating agents are attached, when metal ions are complexed, thus make it possible to obtain readily characterizable electrochemical responses.

Thus, a first subject matter of the invention is an electroactive complex composed of an electroactive polymer which is a homopolymer or copolymer of at least two monomers and which is functionalized by a chelating agent complexed with a metal ion, an antiligand and a ligand which has specifically interacted with said antiligand.

Before describing the invention in detail, certain terms employed in the description and the claims are defined below.

The terms “antiligand” and “ligand” refer without distinction to biological molecules, such as polynucleotides or peptides, but also to chemical molecules.

The antiligand is capable of interacting specifically with the ligand to form a ligand/antiligand conjugate. Mention may be made, as examples of conjugates, of any peptide/antibody, antibody/hapten, hormone/receptor, polynucleotide/polynucleotide or polynucleotide/nucleic acid reversible pair and the like.

The term “polynucleotide” as employed according to the invention denotes a sequence of at least five natural or modified nucleotides (deoxyribonucleotides or ribonucleotides) which is capable of hybridizing, under appropriate hybridization conditions, with an at least partially complementary polynucleotide. The term “modified polynucleotides” is understood to mean, for example, a nucleotide comprising a modified base and/or comprising a modification at the level of the internucleotide bond and/or the level of the backbone. Mention may be made, as examples of modified bases, of inosine, 5-methyldeoxycytidine, 5-(dimethylamino)deoxyuridine, 2,6-diaminopurine and 5-bromodeoxyuridine. Mention may be made, to illustrate a modified internucleotide bond, of phosphorothioate, H phosphonate and alkyl phosphonate bonds. α-Oligonucleotides, such as those disclosed in FR-A-2 607 507, and the PNAs which form the subject of the paper by M. Egholm et al., J. Am. Chem. Soc., 114, 1895-1897 (1992), are examples of polynucleotides composed of nucleotides possessing a modified backbone.

The term “peptide” means in particular any sequence of at least two amino acids, such as protein, protein fragment or oligopeptide, which have been extracted, separated, isolated or synthesized, such as a peptide obtained by chemical synthesis or by expression in a recombinant organism. The following are also included: any peptide in the sequence of which one or more amino acids of the L series are replaced by one or more amino acids of the D series, and vice versa; any peptide in which at least one of the CO—NH bonds is replaced by an NH—CO bond; any peptide in which at least one of the CO—NH bonds is replaced by an NH—CO bond, the chirality of each aminoacyl residue, whether or not it is involved in one or more said CO—NH bonds, either being retained or inverted with respect to the aminoacyl residues constituting a reference peptide (or immunoretroids); and any mimotope.

Mention may be made, to illustrate the various classes of peptides concerned, of adrenocorticotropic hormones or their fragments, angiotensin analogs and their inhibitors, natriuretic peptides, bradykinin and its peptide derivatives, chemotactic peptides, dynorphin and its derivatives, endorphins and their derivatives, enkephalins and their derivatives, enzyme inhibitors, fibronectin fragments and their derivatives, gastrointestinal peptides, opioid peptides, oxytocin, vasopressin, vasotocin and their derivatives, or kinase proteins.

The term “antibody” defines any monoclonal or polyclonal antibody, any fragment of said antibody, such as the Fab, Fab′2 or Fc fragments, and any antibody obtained by genetic modification or recombination.

The terms “to graft”, “to bond”, “to bind” and “to attach”, in the absence of any indication, are employed without distinction in the present text to denote a connection between two entities, without defining the chemical nature thereof. It can thus be a weak bond or a covalent bond.

A connecting group according to the invention connects, via a covalent bond, two chemical entities, after interaction of said two entities, at least one having been activated or activatable beforehand, for the purpose of this interaction, by an activated or activatable group. The bonding group can thus result from the reaction of said activated or activatable group of one entity with a reactive functional group of the other entity, and vice versa, or from the reaction of said activated or activatable group of one entity with another said activated or activatable group of the other entity.

The term “activated group” is understood to mean a group which makes possible, through its agency, the interaction of the entity to which it is attached with another entity. By way of example, it can be an activated ester group, such as the —CO—[O—N-phthalimide] group. The term “activatable group” is understood to mean a group which can be converted to an activated group, for example under certain reaction conditions or when brought into contact with an activated group capable of interacting with it.

The electroactive polymer of the invention is any polymer which is electroactive in water.

The metal ions as present in the complex of the invention are ions capable of retaining a few sites available for complexing with the antiligand after they have complexed with a chelating agent. These available sites are neutralized by water if there is no subsequent complexing, for example with said antiligand.

Mention may be made, as examples of metal ion, of cobalt, nickel, copper and mercury.

The chelating agents used in the invention are chelating agents which complex with the metal ion so that the complexing leaves coordination sites of the ion available for subsequent complexing, in the present case with an antiligand.

Thus, NTA is a tetradentate chelating agent which is suitable for the purposes of the invention. Its complexing with a metal ion, such as copper or nickel, results in the occupation of four of the six coordination sites of said ion, which leaves two sites available for interacting with an antiligand. NTA binds metal ions in a more stable way than other resins available for chelation.

Another example of a chelating agent suitable for the purposes of the invention is IDA, which has three sites available for chelation.

In addition to being bonded to the metal ion, the chelating agent is also bonded to the conducting polymer. This bonding is bonding through the agency of a bonding group as defined above and takes place in a covalent manner.

The ligand and the antiligand are biological or chemical molecules as indicated above. They can be labeled by a tracer capable of directly or indirectly generating a signal, according to techniques widely known to a person skilled in the art, insofar as detection additional to the electrochemical detection is desired.

The antiligand can be bonded to the metal ion via a bonding intermediate, the property of which is to improve the bonding of the antiligand to the metal ion. An example of such an intermediate is histidine or one of its polymeric derivatives, such as polyhistidine.

The complex of the invention as defined above advantageously corresponds to the following characteristics, considered alone or in combination.

The electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, polycarbazole, polyaniline or double-stranded polynucleotides, and/or
the chelating agent is chosen from NTA and IDA, and/or
the metal ion is chosen from copper and mercury cations, and/or
the ligand and the antiligand are biological molecules chosen in particular from polynucleotides and polypeptides, and/or
the antiligand is bonded to histidine or one of its polymeric derivatives.

According to a preferred complex of the invention, the electroactive polymer is a polypyrrole composed of at least two monomers each consisting of a pyrrole ring.

According to a preferred embodiment of this complex, the polypyrrole is a copolymer and comprises a monomer, the pyrrole ring of which is substituted by a —CH₂—COOH or —CH₂—CH₂OH group.

Another subject matter of the invention is an electroactive probe composed of an electroactive polymer which is a homopolymer or copolymer of at least two monomers and which is functionalized by a chelating agent complexed with a metal ion and an antiligand capable of interacting specifically with a ligand. The electroactive probe of the invention has the characteristics of polymer, metal ion, chelating agent and antiligand as indicated above for the complex of the invention.

The electropolymerization stage is carried out by using techniques well known to a person skilled in the art. For example, it can be carried out by subjecting the monomers to variations in electric potential which are sufficient to bring about polymerization by successive oxidation and successive reduction; or else by polymerization with a controlled current (chronopotentiometry) or with a controlled potential (chronoamperometry).

The probes of the invention can be prepared by a process comprising the following stages:
(a) a polymer which is a homopolymer or copolymer composed of at least two monomers, at least one of which is substituted with an activated group, is available,
(b) a chelating agent in aqueous solution is available, and
(c) the polymer which is a homopolymer or copolymer is functionalized by the chelating agent by hydrolysis,
(d) the polymer functionalized with the chelating agent is complexed by contact with an aqueous solution of metal ions,
(e) the antiligand is grafted by contact of the complexed polymer functionalized with the chelating agent and complexed with a metal ion by contact with a solution of antiligand.

This process constitutes a further subject matter of the invention.

According to a preferred embodiment, the polymer is a polypyrrole composed of at least two pyrrole monomers, at least one of which is substituted in the 3-position with an activated ester group.

The probes of the invention have diagnostic applications. Consequently, the invention also relates to a method for the detection of a ligand in a biological sample, according to which said probe is brought into contact under reaction conditions appropriate for the specific ligand/antiligand interaction and a difference in potential or a variation in current between the probe before bringing into contact and the probe after bringing into contact is demonstrated or quantified.

The appropriate reaction conditions depend on the type of reaction concerned.

Thus, in the context of detection of a target polynucleotide, the specific ligand/antiligand interaction is a hybridization. The reaction conditions appropriate for a hybridization are widely known to a person skilled in the art.

In the context of detection of a protein-comprising ligand, the specific ligand/antiligand interaction is that, for example, of an antigen/antibody reaction. The appropriate conditions for such detection are also widely known to a person skilled in the art.

According to one embodiment, the antiligand is bonded to histidine or one of its polymeric derivatives.

Another subject matter of the invention is an electrode, all or part of the surface of which is coated with a probe defined above. Such an electrode can be obtained by any conventional technique well known to a person skilled in the art. By way of example, this preparation can be carried out by depositing a polymer of the invention at the surface of an electrode made of platinum, of gold, of chromium or of titanium covered with gold, of glassy carbon or of a conducting oxide, such as tin oxide or a mixed oxide of tin and of indium.

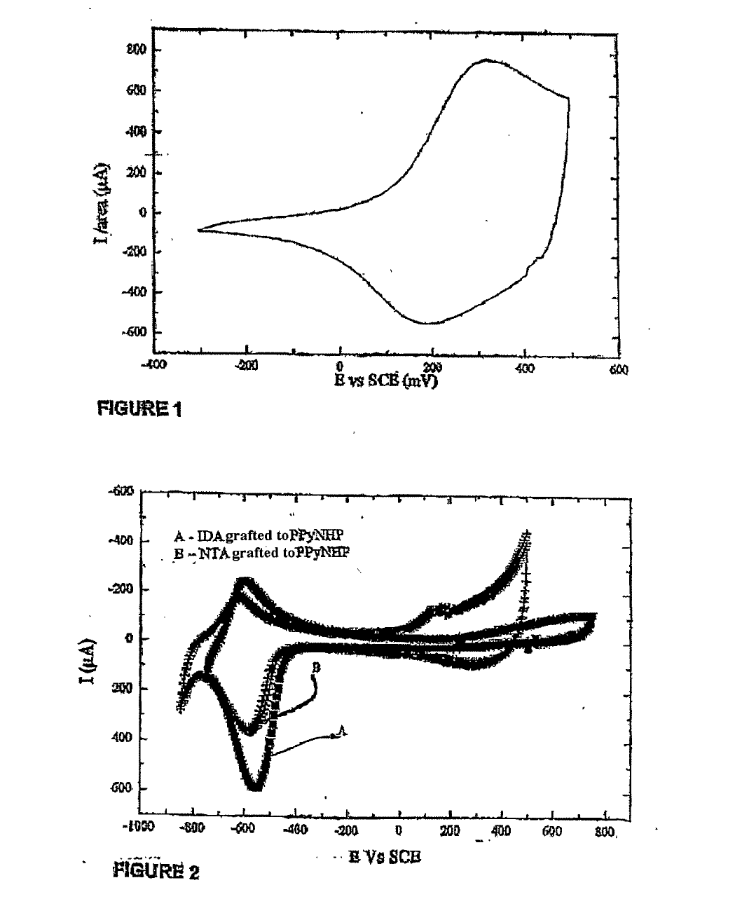

The various subject matters of the invention are illustrated in the following examples, which refer to the appended FIGS. 1 to 8, from which their preferential characteristics and their advantages will emerge.

### EXAMPLE 1

### Preparation of Films Based on Electrically Conducting Polymers

Pyrrole monomers functionalized in the 3-position by an N-hydroxyphthalimide (NHP) were synthesized and subsequently polymerized to produce a poly(3-(carboxymethylpyrrole)-NHP) polymer film carrying active ester groups.

Synthesis of the Monomer:

The 3-carboxymethylpyrrole-NHP monomer was synthesized by esterifying the carboxyl group of 3-pyrroleacetic acid with N-hydroxyphthalimide and dicyclocarboxydiimide, as catalyst, in chloroform, as solvent, at ambient temperature. The reaction scheme is presented below.

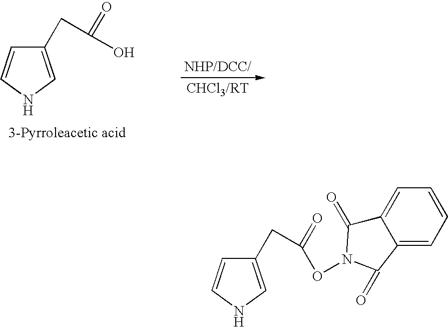

Synthesis of the Polymer:

A 0.1M solution of 3-carboxymethylpyrrole-NHP monomer is prepared in freshly distilled anhydrous acetonitrile in the presence of an electrolyte (LiClO₄, 0.5M). This monomer is polymerized in a 4-compartment cell using a 0.7 cm² platinum electrode, an auxiliary platinum electrode and a saturated calomel electrode as reference electrode, at the controlled potential of 0.9 V, to produce the poly(3-carboxymethylpyrrole-NHP) film. The film obtained is washed with acetone and dried. The electroactivity is subsequently measured in an acetonitrile medium comprising 0.1M LiClO₄ as electrolyte after purging with argon to remove oxygen. Cyclic voltametry is recorded at the rate of 20 mV/s, as represented in FIG. 1. A stable and reversible electrochemical signal with an oxidation peak Eox=317 mV/SCE and confirmation of the electochemical activity in an organic medium are obtained. After analysis, the electrode is washed with acetone and dried.

### EXAMPLE 2

### Grafting of Iminodiacetic Acid (IDA) or of N-(5-amino-1-carboxypentyl)iminodiacetic Acid (NTA) to Conducting Poly(3-carboxymethylpyrrole-NHP) Polymer Films

Once the poly(3-carboxymethylpyrrole-NHP) film has been formed and analyzed as described in example 1, the electrode is immersed in a saturated aqueous solution of NTA or IDA at ambient temperature for 12 hours, washed with ultrapure water and dried. The synthesis of poly(3-carboxymethylpyrrole-IDA) or of poly(3-carboxymethylpyrrole-NTA) is represented below:

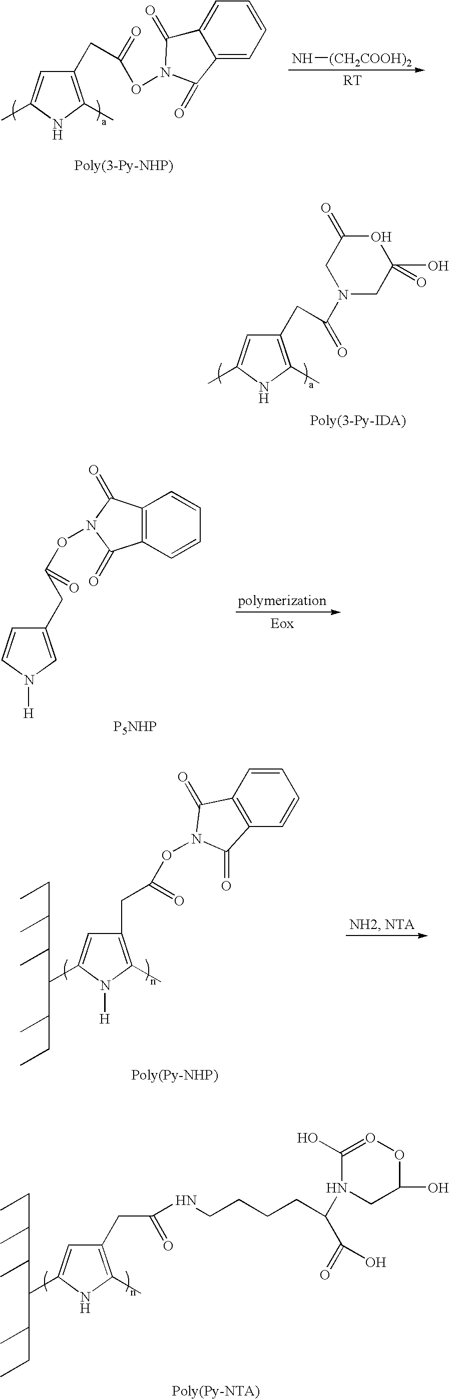

The electrode obtained is washed with ultrapure water and dried, and the electroactivity is monitored in an aqueous medium comprising 0.5M NaCl. The electrochemical analysis is represented in FIG. 2.

The electrochemical signal is stable and reversible in an aqueous medium.

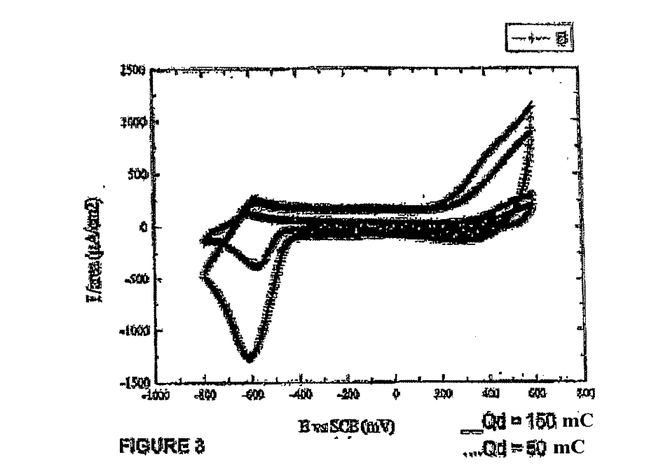

Poly(3-carboxymethylpyrrole-NHP) films with different thicknesses were prepared and the films obtained were grafted with NTA. The electrochemical response, recorded in an aqueous medium in the presence of 0.5M NaCl, confirms the presence of an electrochemically active film in an aqueous medium. Comparison of the charge of poly(3-carboxymethylpyrrole-NHP) deposited at the beginning on the electrode and the calculated charge of NTA grafted to the film suggests that the efficiency for grafting of NTA or of IDA to the film 100%. In other words, the amount of NTA or of IDA grafted to the poly(3-carboxy)pyrrole film depends on the amount of 3-carboxymethylpyrrole-NHP units present on the electrodes, as illustrated by the curves of FIG. 3.

### EXAMPLE 3

### Complexing of the Poly(3-carboxymethylpyrrole-NTA) Film with Copper on the Electrode

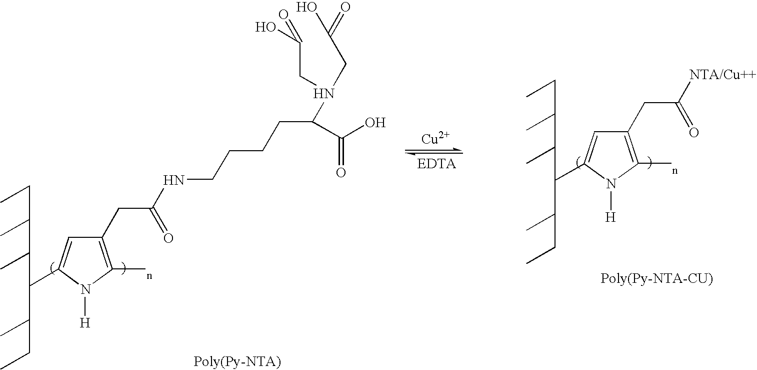

The electrode comprising the poly(3-carboxymethylpyrrole-NTA) film was analyzed electrochemically in an aqueous medium, washed with deionized water and dried, and it is subsequently immersed in an aqueous solution of CuCl₂ in the presence of 0.5M NaCl at ambient temperature for 3 hours.

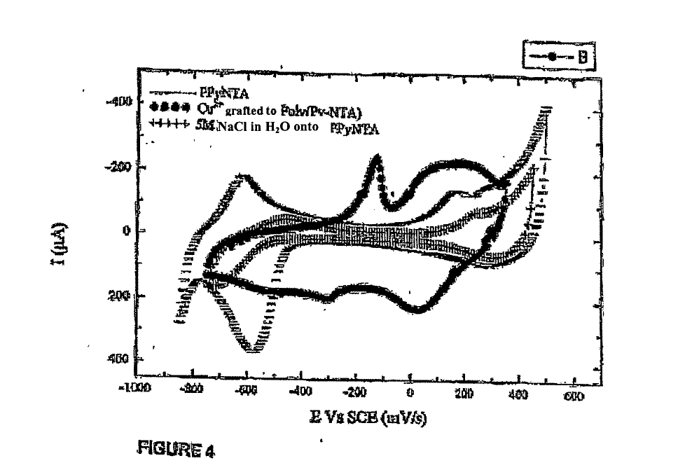

The electrode is subsequently rinsed in deionized water, dried and electrochemically analyzed in an aqueous solution comprising 0.5M NaCl. The disappearance of the electrochemical signal of poly(3-carboxymethylpyrrole-NTA) and the appearance of a peak characteristic of the oxidation of Cu⁺ to Cu²⁺ at −0.2 V −0.35 V, which is stable but nonreversible and electoactive in an aqueous medium, confirms the complexing of copper with the poly(3-carboxymethylpyrrole-NTA) (FIG. 4).

### EXAMPLE 4

### Grafting the Polyhistidine to Polypyrrole-NTA/Cu²⁺ Films

The electrodes comprising a polypyrrole-NTA/Cu²⁺ film are washed with water, then dried and immersed in a PBS buffer solution of polyhistidine with a molecular weight of 6300 g in an amount which is equimolecular with the amount of copper complexed to the polypyrrole-NTA film comprising NaCl for one hour at ambient temperature.

After washing with a buffer solution, they are dried and then analyzed electrochemically in an aqueous solution comprising 0.5M NaCl.

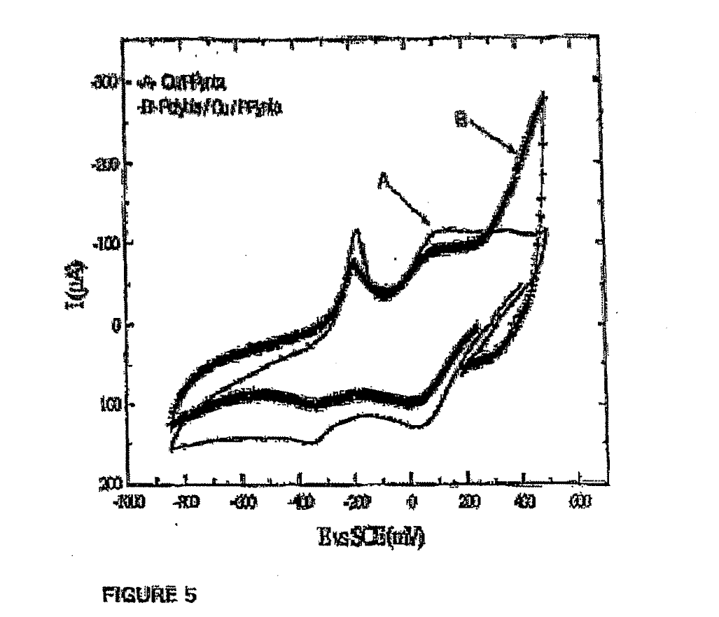

It is observed, on the voltammogram illustrated by the curves in FIG. 5, that the signals for copper are still present.

Demonstration of the Reversibility of the Grafting:

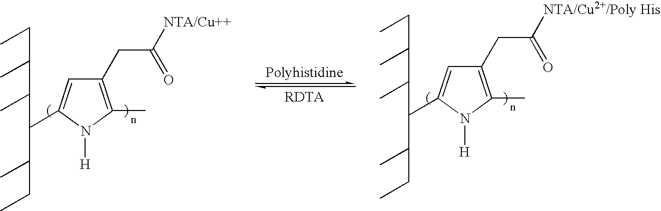

The electrodes comprising grafted polyhistidine obtained above are treated by immersion in an aqueous EDTA solution at ambient temperature for 15 minutes, rinsed and then dried.

They are subsequently analyzed electrochemically in an aqueous solution comprising 0.5M NaCl.

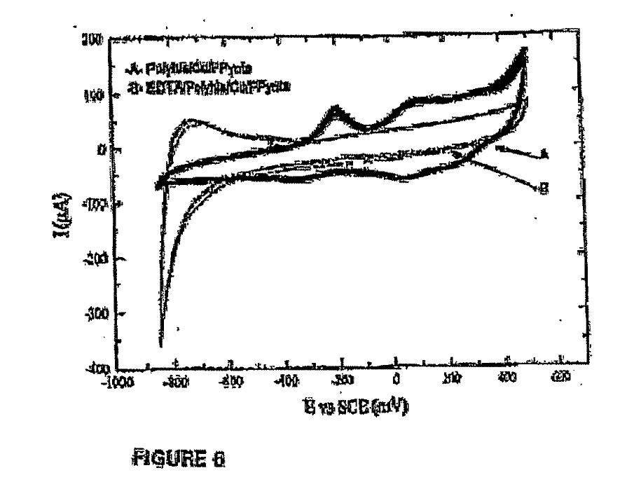

It is observed, on the voltammogram illustrated by the curves in FIG. 6, that the peak characteristic of copper has disappeared, which means that the EDTA has displaced the copper from the complex with the NTA of the film.

It may be concluded that the complexing and the decomplexing of copper on a polypyrrole-NTA film is a reversible phenomenon.

### EXAMPLE 5

### Immobilization of an Antigen on a Polypyrrole-NTA Film Complexed by Cu²⁺ Ions

The immobilized protein RH24 is a protein modified by addition of 6 histidine amino acids in the N-terminal position of the P24 protein naturally synthesized by Escherichia coli with a theoretical molecular mass of 26 950 g.

The grafting is carried out by incubating 5 nmol of antigen for 3 hours at ambient temperature on the Cu²⁺/polypyrrole-NTA film. They are subsequently analyzed electrochemically in an aqueous solution comprising 0.5M NaCl.

Cyclic voltammetry is recorded at the rate of 20 mV/s.

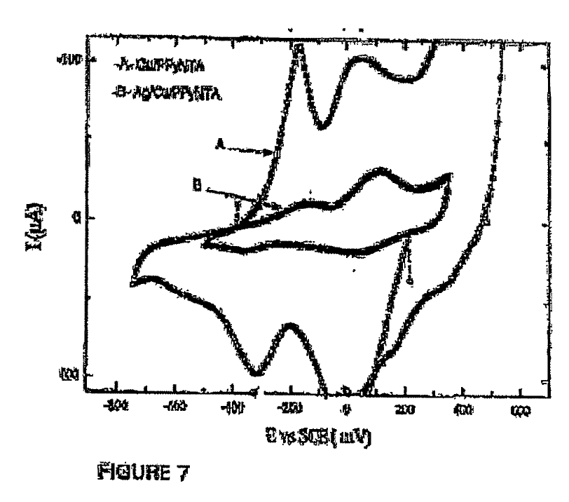

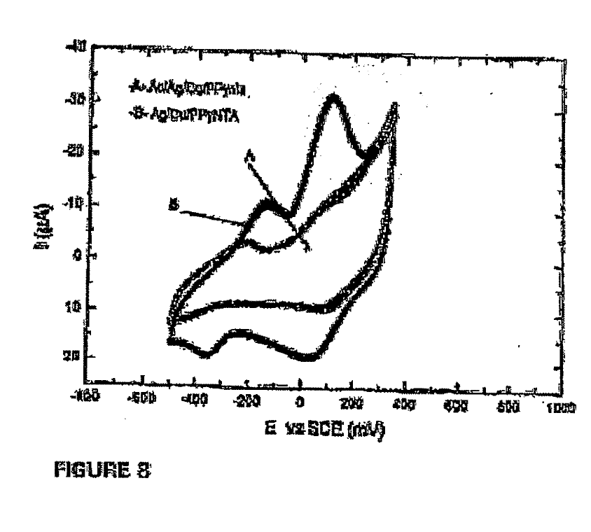

In the voltammogram represented in FIG. 7, a decrease in the signal is observed related to the complexity of the antigen.

### EXAMPLE 6

### Detection of an Antibody on a Polypyrrole-NTA Film Complexed by Cu²⁺ Ions on Which is Immobilized an Antigen

Detection is carried out by immersion of the electrode comprising a polypyrrole-NTA film complexed by Cu²⁺ ions on which is immobilized an antigen in a solution of 0.6 nmol of antibody specific to the antigen.

They are subsequently analyzed electrochemically in an aqueous solution comprising 0.5M NaCl.

Cyclic voltammetry is recorded at the rate of 20 mV/s.

In the voltammogram represented in FIG. 8, a modification to the signal is observed related to the antigen/antibody coupling.

1. An electroactive complex composed of an electroactive polymer which is a homopolymer or copolymer of at least two monomers and which is functionalized by a chelating agent complexed with a metal ion, an antiligand and a ligand which has specifically interacted with said antiligand.

2. The complex as claimed in claim 1, characterized in that the electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, polycarbazole, polyaniline or double-stranded polynucleotides.

3. The complex as claimed in claim 1, characterized in that the chelating agent is chosen from NTA (nitrilotriacetate) or IDA (iminodiacetate).

4. The complex as claimed in claim 1, characterized in that the metal ion is chosen from copper or mercury cations.

5. The complex as claimed in claim 1, characterized in that the ligand and the antiligand are biological molecules chosen in particular from polynucleotides and polypeptides.

6. The complex as claimed in claim 1, characterized in that the antiligand is bonded to histidine or one of its polymeric derivatives.

7. The complex as claimed in claim 2, characterized in that the polypyrrole is a copolymer and comprises a monomer, the pyrrole ring of which is substituted by a —CH₂—COOH or —CH₂—CH₂OH group.

8. An electroactive probe composed of an electroactive polymer which is a homopolymer or copolymer of at least two monomers and which is functionalized by a chelating agent complexed with a metal ion and an antiligand capable of interacting specifically with a ligand.

9. The electroactive probe as claimed in claim 8, characterized in that the electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, poly-carbazole, polyaniline or double-stranded poly-nucleotides.

10. The electroactive probe as claimed in claim 1, characterized in that the chelating agent is chosen from NTA (nitrilotriacetate) or IDA (iminodiacetate).

11. The electroactive probe as claimed in claim 1, characterized in that the metal ion is chosen from copper or mercury cations.

12. The electroactive probe as claimed in claim 1, characterized in that the antiligand is a biological molecule chosen in particular from polynucleotides and polypeptides.

13. The electroactive probe as claimed in claim 1, characterized in that the antiligand is bonded to histidine or one of its polymeric derivatives.

14. The electroactive probe as claimed in claim 9, characterized in that the polypyrrole is a copolymer and comprises a monomer, the pyrrole ring of which is substituted by a —CH₂—COOH or —CH₂—CH₂OH group.

15. A process for preparing a probe as defined in claim 8, characterized in that it comprises the following stages:
(a) a polymer which is a homopolymer or copolymer composed of at least two monomers, at least one of which is substituted by an activated group, is available,
(b) a chelating agent in aqueous solution is available, and
(c) the polymer which is a homopolymer or copolymer is functionalized by the chelating agent by hydrolysis,
(d) the polymer functionalized with the chelating agent is complexed by contact with an aqueous solution of metal ions,
(e) the antiligand is grafted by contact of the complexed polymer functionalized with the chelating agent and complexed with a metal ion by contact with a solution of antiligand.

16. The process as claimed in claim 5, characterized in that the polymer is a polypyrrole composed of at least two pyrrole monomers, at least one of which is substituted on the carbon in the 3-position by an activated group.

17. A method for the detection of a ligand in a biological sample, characterized in that a probe as claimed in claim 8 is brought into contact under reaction conditions appropriate for the specific antiligand/ligand interaction and in that a difference in potential or a variation in current between the probe before bringing into contact and the probe after bringing into contact is demonstrated or quantified.

18. The method as claimed in claim 17, characterized in that the antiligand is bonded to histidine or one of its polymeric derivatives.

19. An electrode, all or part of the surface of which is coated with a probe as claimed in claim 8.
